(19) United States
(12) Patent Application Publication
(10) Pub. No.: US 2019/0027727 A1
(43) Pub. Date: Jan. 24, 2019

(54) LONG POROUS SEPARATOR SHEET, ROLL OF THE SAME, METHOD FOR PRODUCING THE SAME, AND LITHIUM-ION BATTERY

(71) Applicant: Sumitomo Chemical Company, Limited, Tokyo (JP)

(72) Inventors: Tomoaki OZEKI, Nihama-shi, Ehime (JP); Masateru SEMBARA, Nihama-shi, Ehime (JP); Daizaburo YASHIKI, Niihama-shi, Ehime (JP)

(21) Appl. No.: 15/312,924

(22) PCT Filed: Apr. 15, 2016
(86) PCT No.: PCT/JP2016/062186

§ 371 Date: Nov. 21, 2016

(51) Int. Cl. H01M 2/16; B26D 1/143; B26D 7/32; B65H 27/00; H01M 10/0525; H01M 2/14; H01M 2/18

(52) U.S. Cl. CPC H01M 2/1686; B26D 1/1435; B26D 7/32; H01M 2/18; H01M 10/0525; H01M 2/145; B65H 27/00

(57) ABSTRACT

A long separator sheet (12a′, 12b′) has a right edge part (12c′) that is in a trapezoidal shape and a left edge part (12d′) having a curved shape. Therefore, it is possible to provide a long porous separator sheet which satisfies both a good electrolyte take-in property (i.e., liquid absorption property) and a good electrolyte retaining property (i.e., liquid retention property).

### TECHNICAL FIELD

The present invention relates to (i) a long porous separator sheet which has been slit so as to be used in a battery such as a lithium-ion battery, (ii) a porous separator roll prepared by winding the long porous separator sheet on a core, (iii) a method for producing the long porous separator sheet, and (iv) a lithium-ion battery including a porous separator which has been obtained by cutting the long porous separator sheet in a predetermined length.

### BACKGROUND ART

A separator original sheet used for a lithium-ion battery is slit (cut) in a lengthwise direction of the original sheet, and it is thus possible to obtain a plurality of long separator sheets each of which has a predetermined slit width in a direction perpendicular to the lengthwise direction.

Each of the plurality of long separator sheets is wound on a core and is then supplied to a battery production process as a separator roll. In the battery production process, each of the plurality of long separator sheets is cut in a predetermined length in a direction perpendicular to the slit width, and is thus used as a separator.

As such, a lateral surface itself of the long separator sheet which has been obtained by slitting serves as a lateral surface of a battery separator, and therefore a shape of the lateral surface is important.

In view of this, Patent Literature 1 discloses a separator which includes a base material layer and an inorganic layer and has a lateral surface that is formed into a taper shape in order to inhibit the inorganic layer from being peeled off from the base material layer in a case where the separator is bent.

Meanwhile, Patent Literature 2 discloses that a photosensitive-material is cut with a shear cutting method so that a lateral surface thereof lies at a right angle.

### CITATION LIST

### Patent Literature

[Patent Literature 1]

Japanese Patent Application-Publication Tokukai No. 2012-199020 (Publication date: Oct. 18, 2012)

[Patent Literature 2]

Japanese Patent Application Publication Tokukai No. 2005-66796 (Publication date: Mar. 17, 2005)

### SUMMARY OF INVENTION

### Technical Problem

In general, in a wound-type battery, a separator is provided between a positive electrode and a negative electrode and is wound, together with the positive electrode and the negative electrode, in a machine direction (MD: a lengthwise direction of a long separator sheet). Further, the positive electrode material, the negative electrode material, and the separator which have been wound are inserted into a cylindrical container, and then an electrolyte is supplied from a side of a lateral surface of a battery separator which lateral surface is a lateral surface (i.e., slit surface) of the long separator sheet.

That is, the electrolyte is supplied from a side of one of two opposite lateral surfaces of the battery separator, and the other of the two opposite lateral surfaces is to make contact with a bottom surface of the cylindrical container. From this, it may be possible to provide a battery separator that satisfies both a good electrolyte take-in property (i.e., liquid absorption property) and a good electrolyte retaining property (i.e., liquid retention property) by (i) forming a lateral surface of the battery separator, which lateral surface is on an electrolyte supplying side, into a shape that can achieve a good electrolyte take-in property (liquid absorption property) and (ii) forming a lateral surface of the battery separator, which lateral surface makes contact with the bottom surface of the cylindrical container, into a shape that can achieve a good electrolyte retaining property (liquid retention property).

However, Patent Literature 1 merely discloses that both lateral surfaces of the separator are formed into the taper shape in order to inhibit the inorganic layer from being peeled off from the base material layer and does not give attention to improvement in electrolyte take-in property (i.e., liquid absorption property) or electrolyte retaining property (i.e., liquid retention property) at all.

Moreover, Patent Literature 2 merely discloses that the photosensitive material is cut with a shear cutting method so that both lateral surfaces thereof lie at a right angle, and does not give attention to improvement in electrolyte take-in property (i.e., liquid absorption property) or electrolyte retaining property (i.e., liquid retention property) at all.

The present invention is accomplished in view of the problem, and its object is to provide (i) a long porous separator sheet which satisfies both a good electrolyte take-in property (i.e., liquid absorption property) and a good electrolyte retaining property (i.e., liquid retention property) and (ii) a method for producing such a long porous separator sheet.

### Solution to Problem

In order to attain the object, the long porous separator sheet of the present invention is a long porous separator sheet obtained by slitting a porous separator original sheet in a lengthwise direction of the porous separator original sheet, the long porous separator sheet including: a first lateral surface and a second lateral surface which are opposite in a transverse direction that is perpendicular to the lengthwise direction, the porous separator original sheet being slit in a first slitting section and a second slitting section, each of the first slitting section and the second slitting section including an upper blade and a lower blade which rotate in different directions, the upper blade making contact with one of two lower blades in a space formed between the two lower blades which are adjacent in the transverse direction, the first lateral surface being formed by the upper blade and the space in one of the first slitting section and the second slitting section, and the second lateral surface being formed by the upper blade and the one of two lower blades that makes contact with the upper blade in the other of the first slitting section and the second slitting section.

According to the configuration, the long porous separator sheet has (i) the first lateral surface that is formed by the upper blade and the space in one of the first slitting section and the second slitting section and (ii) the second lateral surface that is formed by the upper blade and the one of two lower blades that makes contact with the upper blade in the other of the first slitting section and the second slitting section.

When the porous separator original sheet is slit in the first and second slitting sections, the pores in the first lateral surface formed by the upper blade and the space are hardly damaged. Meanwhile, in the second lateral surface formed by the upper blade and the one of two lower blades that makes contact with the upper blade, the pores are damaged by the slitting.

As such, in the first lateral surface and the second lateral surface of the long porous separator sheet, damages to the pores vary greatly, and thus the first lateral surface becomes a lateral surface having a good electrolyte take-in property (i.e., liquid absorption property) and the second lateral surface becomes a lateral surface having a good electrolyte retaining property (i.e., liquid retention property).

Therefore, it is possible to provide the long porous separator sheet which satisfies both a good electrolyte take-in property (i.e., liquid absorption property) and a good electrolyte retaining property (i.e., liquid retention property).

In order to attain the object, the long porous separator sheet of the present invention is a long porous separator sheet including a first lateral surface and a second lateral surface which are opposite in a transverse direction that is perpendicular to a lengthwise direction, the first lateral surface being an inclined plane, and the second lateral surface being a curved surface.

According to the configuration, the long porous separator sheet has the first lateral surface which is an inclined plane and the second lateral surface which is a curved surface.

When the second lateral surface which is the curved surface is formed, the second lateral surface of the long porous separator sheet is stretched, and therefore pores in the vicinity of the second lateral surface are damaged. Meanwhile, the first lateral surface of the long porous separator sheet is the inclined plane, and therefore pores in the vicinity of the first lateral surface are hardly damaged.

As such, in the first lateral surface and the second lateral surface of the long porous separator sheet, damages to the pores vary greatly, and thus the first lateral surface becomes a lateral surface having a good electrolyte take-in property (i.e., liquid absorption property) and the second lateral surface becomes a lateral surface having a good electrolyte retaining property (i.e., liquid retention property).

Therefore, it is possible to provide the long porous separator sheet which satisfies both a good electrolyte take-in property (i.e., liquid absorption property) and a good electrolyte retaining property (i.e., liquid retention property).

In order to attain the object, the long porous separator sheet of the present invention is a long porous separator sheet including a first lateral surface and a second lateral surface which are opposite in a transverse direction that is perpendicular to a lengthwise direction, a blocked ratio of pores in the first lateral surface being smaller than that in the second lateral surface.

According to the configuration, in the long porous separator sheet, a blocked ratio of pores in the first lateral surface is smaller than that in the second lateral surface.

From this, the first lateral surface of the long porous separator sheet becomes a lateral surface having a good electrolyte take-in property (i.e., liquid absorption property), and the second lateral surface becomes a lateral surface having a good electrolyte retaining property (i.e., liquid retention property).

Therefore, it is possible to provide the long porous separator sheet which satisfies both a good electrolyte take-in property (i.e., liquid absorption property) and a good electrolyte retaining property (i.e., liquid retention property).

In order to attain the object, the method of the present invention for producing a long porous separator sheet includes the step of slitting a porous separator original sheet in a lengthwise direction of the porous separator original sheet, in the slitting step, a first lateral surface and a second lateral surface being formed, which are opposite in a transverse direction that is perpendicular to the lengthwise direction, with use of a first slitting section and a second slitting section, each of the first slitting section and the second slitting section including an upper blade and a lower blade which rotate in different directions, the upper blade making contact with one of two lower blades in a space formed between the two lower blades which are adjacent in the transverse direction, the first lateral surface being formed by the upper blade and the space in one of the first slitting section and the second slitting section, and the second lateral surface being formed by the upper blade and the one of two lower blades that makes contact with the upper blade in the other of the first slitting section and the second slitting section.

According to the method, it is possible to provide a method for producing a long porous separator sheet which satisfies both a good electrolyte take-in property (i.e., liquid absorption property) and a good electrolyte retaining property (i.e., liquid retention property).

### Advantageous Effects of Invention

According to an aspect of the present invention, it is possible to provide (i) a long porous separator sheet which satisfies both a good electrolyte take-in property (i.e., liquid absorption property) and a good electrolyte retaining property (i.e., liquid retention property) and (ii) a method for producing such a long porous separator sheet.

### BRIEF DESCRIPTION OF DRAWINGS

FIG. 1 is a schematic view illustrating a cross sectional configuration of a lithium-ion secondary battery.

FIG. 2 is a schematic view illustrating details of the configuration of the lithium-ion secondary battery illustrated in FIG. 1.

FIG. 3 is a schematic view illustrating another configuration of the lithium-ion secondary battery illustrated in FIG. 1.

(a) of FIG. 4 is a schematic view illustrating a configuration of a slitting apparatus for slitting a separator original sheet, and (b) of FIG. 4 is a view illustrating a state in which the separator original sheet is slit into a plurality of long separator sheets by the slitting apparatus.

(a) of FIG. 5 is a view illustrating a cutting device which operates in a shear cutting mode and is provided in the slitting apparatus illustrated in FIG. 4, (b) of FIG. 5 is a view illustrating a slitting section which is provided in the cutting device that operates in the shear cutting mode, and (c) of FIG. 5 is a view illustrating a state in which a separator original sheet is slit by the slitting section.

FIG. 6 is a view illustrating shapes of respective right and left edge parts of a long separator sheet.

FIG. 7 is a view illustrating shapes of respective right and left edge parts of the long separator sheet in a vicinity of a surface B of the long separator sheet.

FIG. 8 is a view for explaining a state of pores in right and left lateral surfaces of a long separator sheet.

FIG. 9 is a view for explaining a method for evaluating an electrolyte take-in property of a long separator sheet.

FIG. 10 is a view showing results of evaluating an ethanol (i.e., simulant of electrolyte) take-in property.

FIG. 11 is a view for explaining a method for evaluating an electrolyte retaining property of a long separator sheet.

FIG. 12 is a view showing results of evaluating an ethanol (i.e., simulant of electrolyte) retaining property.

### DESCRIPTION OF EMBODIMENTS

[Basic Configuration]

The following description will discuss in order a lithium-ion secondary battery, a separator, a heat resistant separator, a method for producing the heat resistant separator, and a slitting apparatus.

(Lithium-Ion Secondary Battery)

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

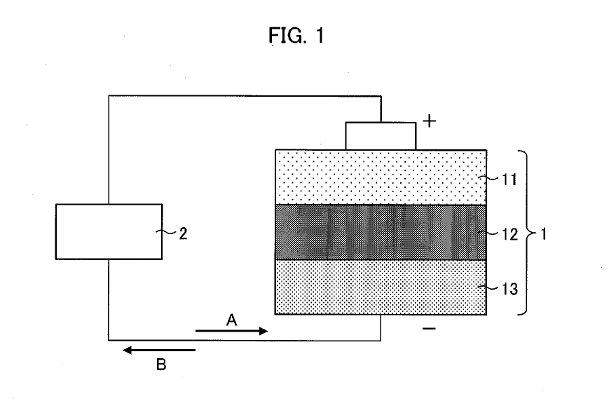

FIG. 1 is a schematic view illustrating a cross sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. While the lithium-ion secondary battery 1 is being charged, electrons move in a direction A. On the other hand, while the lithium-ion secondary battery 1 is being discharged, electrons move in a direction B.

(Separator)

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film that separates the cathode 11 and the anode 13, allowing lithium ions to move between the cathode 11 and the anode 13. The separator 12 contains, for example, polyolefin such as polyethylene or polypropylene as a material.

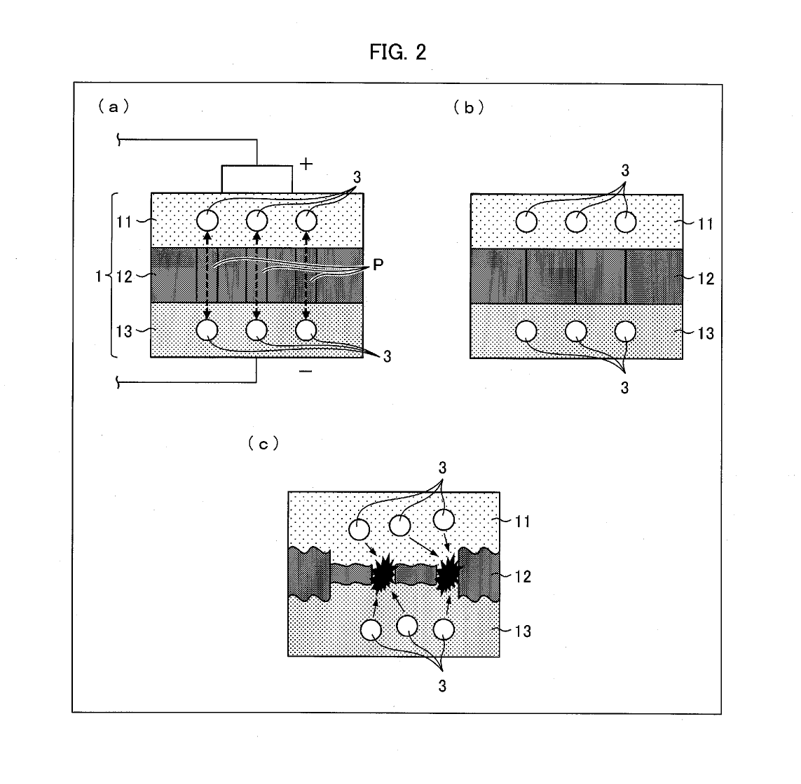

FIG. 2 is a schematic view illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

Here, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens and the pores P are blocked as illustrated in (b) of FIG. 2. As a result, the separator 12 shrinks. This stops the movement of the lithium ions 3, and consequently stops the above described temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving. Consequently, the temperature continues rising.

(Heat Resistant Separator)

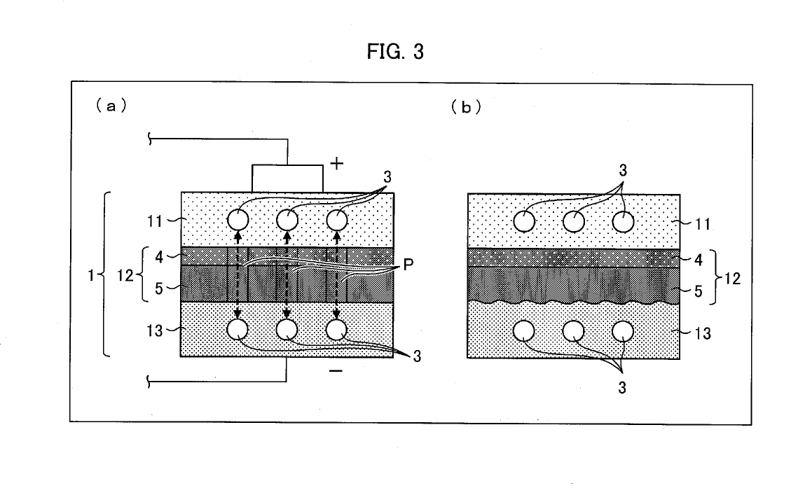

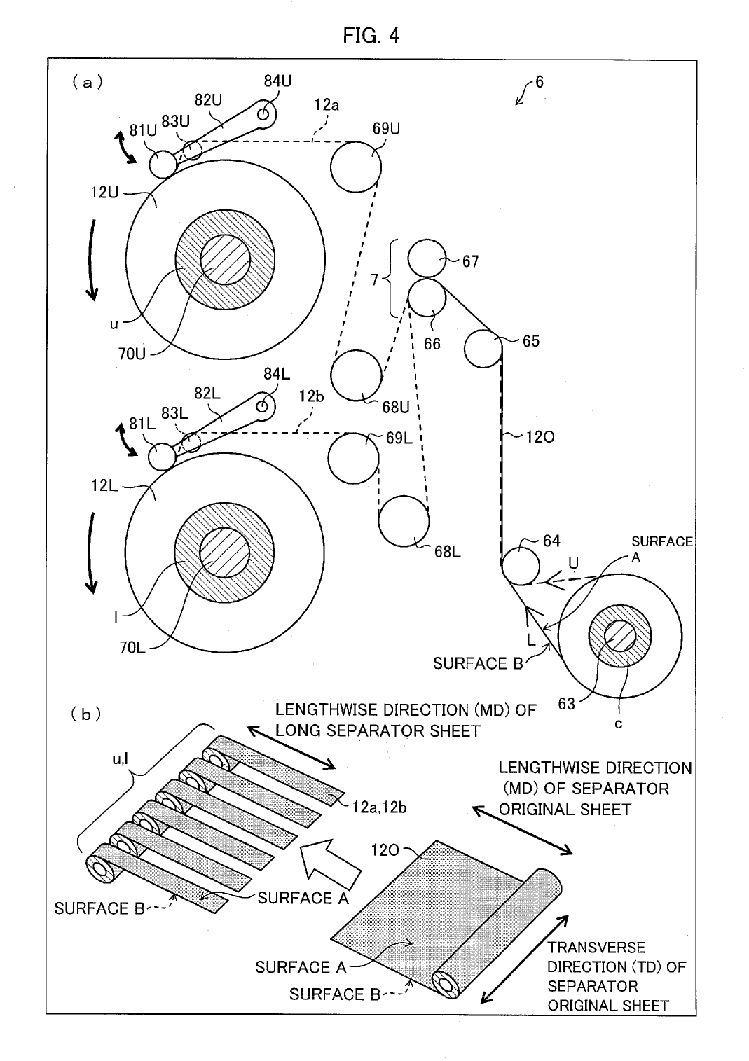

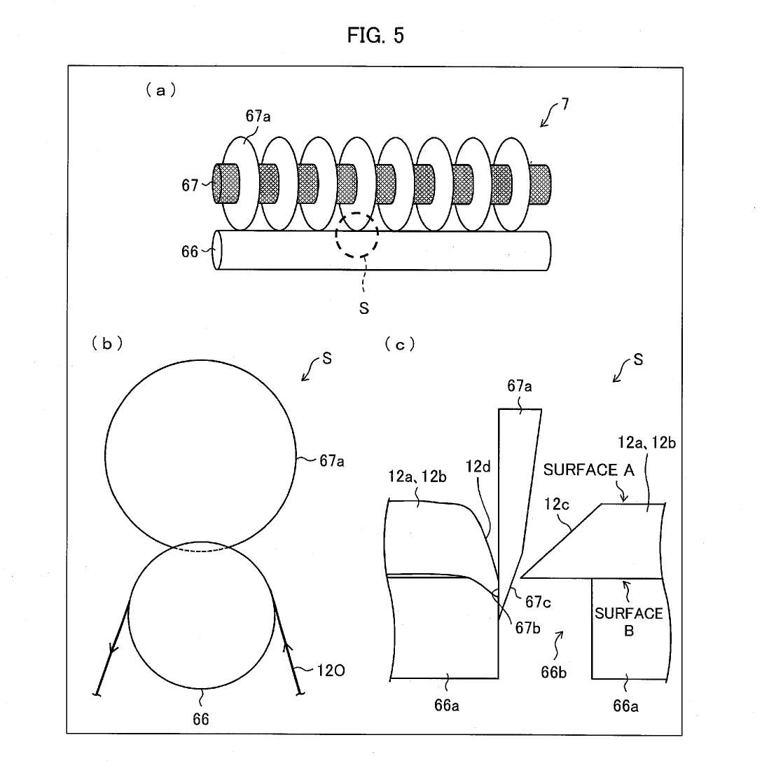

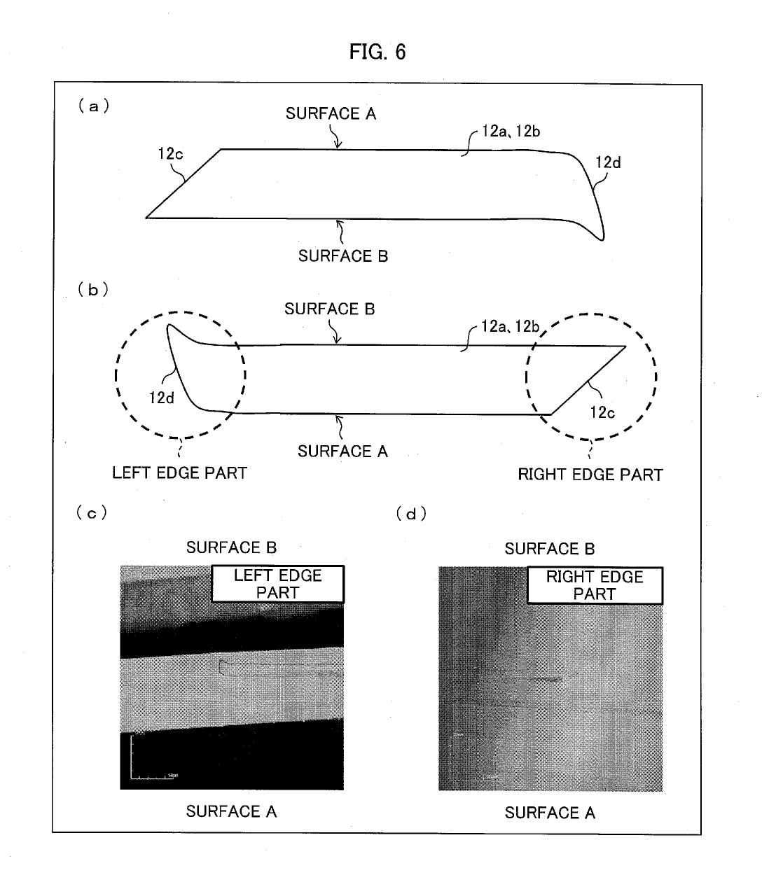

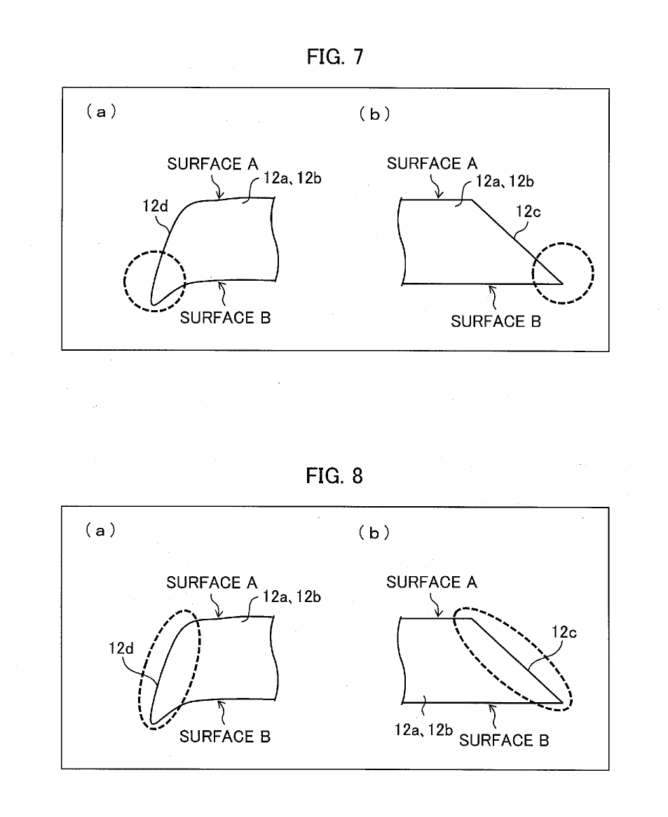

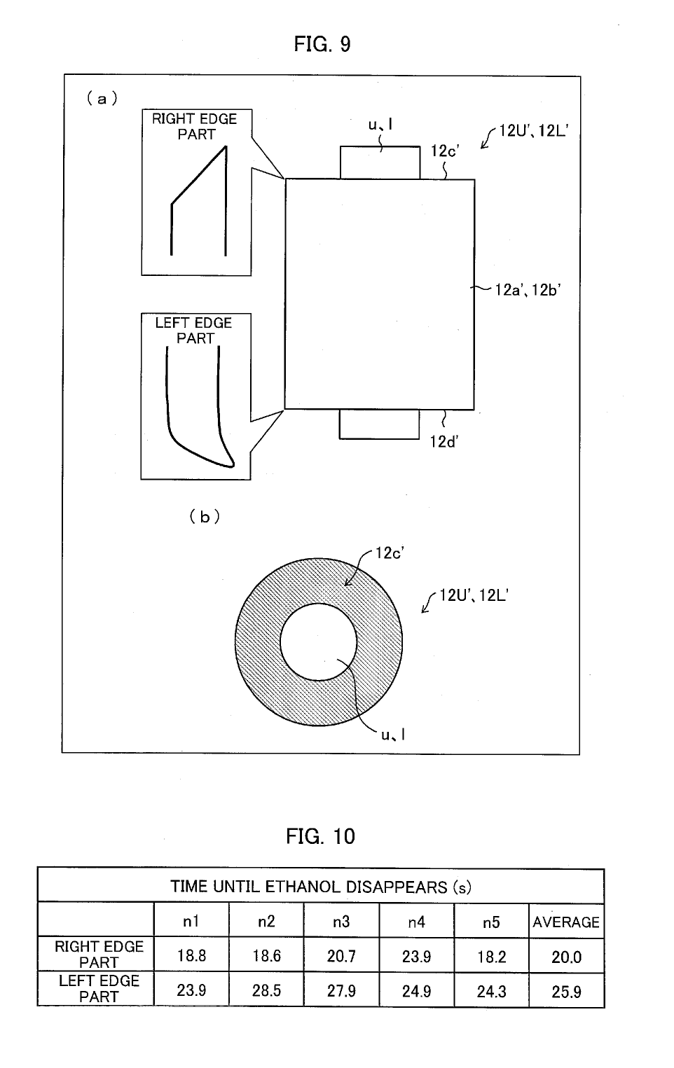

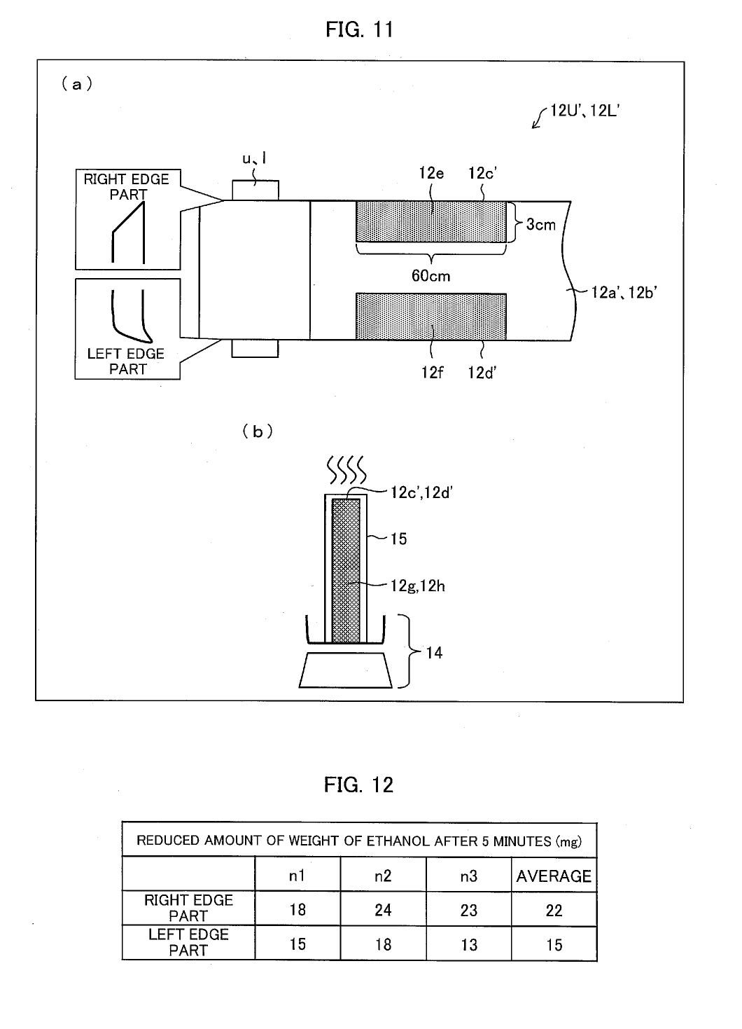

FIG. 3 is a schematic view illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the separator 12 can be a heat resistant separator that includes a porous film 5 and a heat resistant layer 4. The heat resistant layer 4 is laminated on a surface of the porous film 5 which surface is on a cathode 11 side. Note that the heat resistant layer 4 can alternatively be laminated on a surface of the porous film 5 which surface is on an anode 13 side, or both surfaces of the porous film 5. Further, the heat resistant layer 4 is provided with pores which are similar to the pores P. Normally, the lithium ions 3 move through the pores P and the pores of the heat resistant layer 4. The heat resistant layer 4 contains, for example, wholly aromatic polyamide (aramid resin) as a material.

As illustrated in (b) of FIG. 3, even in a case where the temperature of the lithium-ion secondary battery 1 sharply rises and as a result, the porous film 5 melts or softens, the shape of the porous film 5 is maintained because the heat resistant layer 4 supports the porous film 5. Therefore, such a sharp temperature rise results in only melting or softening of the porous film 5 and consequent blocking of the pores P. This stops movement of the lithium ions 3 and consequently stops the above-described excessive discharging or excessive charging. In this way, the separator 12 can be prevented from being destroyed.

(Production Steps of the Heat Resistant Separator)

How to produce the heat resistant separator of the lithium-ion secondary battery 1 is not specifically limited. The heat resistant separator can be produced by a well-known method. The following discussion assumes a case where the porous film 5 contains polyethylene as a main material. However, even in a case where the porous film 5 contains another material, the similar steps can still be applied to production of the separator 12.

For example, it is possible to employ a method including the steps of first forming a film by adding a plasticizer to a thermoplastic resin, and then removing the plasticizer with an appropriate solvent. For example, in a case where the porous film 5 is made of a polyethylene resin containing ultra high molecular weight polyethylene, it is possible to produce the porous film 5 by the following method.

This method includes (1) a kneading step of obtaining a polyethylene resin composition by kneading a ultrahigh molecular weight polyethylene and an inorganic filler such as calcium carbonate, (2) a rolling step of forming a film with the polyethylene resin composition, (3) a removal step of removing the inorganic filler from the film obtained in the step (2), and (4) a stretching step of obtaining the porous film 5 by stretching the film obtained in the step (3).

In the removal step, many fine pores are provided in the film. The fine pores of the film stretched in the stretching step become the above-described pores P. The porous film 5 formed as a result is a polyethylene microporous film having a predetermined thickness and a predetermined air permeability.

Note that, in the kneading step, 100 parts by weight of the ultrahigh molecular weight polyethylene, 5 parts by weight to 200 parts by weight of a low-molecular weight polyolefin having a weight-average molecular weight of 10000 or less, and 100 parts by weight to 400 parts by weight of the inorganic filler can be kneaded.

Subsequently, in a coating step, the heat resistant layer 4 is formed on a surface of the porous film 5. For example, on the porous film 5, an aramid/NMP (N-methylpyrrolidone) solution (coating solution) is applied, and thereby the heat resistant layer 4 that is an aramid heat resistant layer is formed. The heat resistant layer 4 can be provided on only one surface or both surfaces of the porous film 5. Alternatively, for coating, the heat resistant layer 4 can be formed by using a mixed solution containing a filler such as alumina/carboxymethyl cellulose.

A method for coating the porous film 5 with a coating solution is not specifically limited as long as uniform wet coating can be carried out by the method. The method can be a conventionally well-known method such as a capillary coating method, a spin coating method, a slit die coating method, a spray coating method, a dip coating method, a roll coating method, a screen printing method, a flexo printing method, a bar coater method, a gravure coater method, or a die coater method. The heat resistant layer 4 has a thickness which can be controlled by adjusting (i) a thickness of a coating wet film and (ii) a solid-content concentration in the coating solution.

Note that it is possible to use a resin film, a metal belt, a metal drum, or the like as a support with which the porous film 5 is fixed or transferred in coating.

As described above, it is possible to produce the separator 12 (heat resistant separator) in which the heat resistant layer 4 is laminated on the porous film 5. Thus produced separator is wound on a cylindrical core. Note that a subject to be produced by the above production method is not limited to the heat resistant separator. The above production method does not necessarily include the coating step. In a case where the method includes no coating step, the subject to be produced is a separator including no heat resistant layer.

(Slitting Apparatus)

The heat resistant separator or the separator including no heat resistant layer (hereinafter, referred to as “separator”) preferably has a width (hereinafter, referred to as “product width”) suitable for application products such as the lithium-ion secondary battery 1. However, for improving productivity, the separator is produced so as to have a width that is equal to or larger than a product width. This is referred to as a separator original sheet. After the separator original sheet is once produced, the separator original sheet is cut (slit) by the slitting apparatus so that a “separator width” (which means a length in a direction substantially perpendicular to a lengthwise direction and a thickness direction) of the separator original sheet becomes the product, width, and thus a long separator sheet is obtained.

In the following descriptions, a wide separator which is before being slit is referred to as “separator original sheet”, and a separator which has been slit so as to have a separator width that is the product width is particularly referred to as “long separator sheet”. Note that “slitting” means to slit the separator original sheet in the lengthwise direction (i.e., a flow direction of the film during production; MD: machine direction), and that “cutting” means to cut the long separator sheet in a transverse direction (TD). The “transverse direction (TD)” means a direction which is substantially perpendicular to the lengthwise direction (MD) and the thickness direction of the long separator sheet.

### Embodiment 1

(Configuration of Slitting Apparatus)

(a) of FIG. 4 is a schematic view illustrating a configuration of a slitting apparatus 6 which includes a cutting device 7 that operates in a shear cutting mode. (b) of FIG. 4 is a view illustrating a state in which an original sheet 120 of a separator (porous separator) is slit into long separator sheets (long porous separator sheets) 12a and 12b by the slitting apparatus 6.

Embodiment 1 exemplifies the separator original sheet 120 in which a wholly aromatic polyamide (aramid resin) as the heat resistant layer 4 is laminated on one surface of the porous film 5, as illustrated in FIG. 3. Note, however, that Embodiment 1 is not limited to this, and the separator original sheet 120 can be a porous film 5 on which no heat resistant layer 4 is laminated or can be a sheet in which heat resistant layers 4 are laminated on both surfaces of the porous film 5.

As illustrated in (a) of FIG. 4, the slitting apparatus 6 includes a wind-off roller 63 which is rotatably supported and has a cylindrical shape, rollers 64, 65, 68U, 68L, 69U, and 69L, a first touch roller 81U, a second touch roller 81L, a first arm 82U, a second arm 82L, a first take-up assisting roller 83U, a second take-up assisting roller 83L, a first winding-up roller 70U, a second winding-up roller 70L, and the cutting device 7.

In the slitting apparatus 6, a cylindrical core c is attached onto the wind-off roller 63, and the separator original sheet 120 is wound on the core c. The separator original sheet 120 is wound off from the core c along a route U or L. In a case where the separator original sheet 120 is to be transferred while a surface A of the separator original sheet 120 serves as an upper surface, the separator original sheet 120 is wound off along the route L. Whereas, in a case where the separator original sheet 120 is to be transferred while a surface B of the separator original sheet 120 serves as an upper surface, the separator original sheet 120 is wound off along the route U. Note that, in Embodiment 1, the separator original sheet 120 is transferred while the surface A serves as an upper surface, and therefore the separator original sheet 120 is wound off along the route L.

In Embodiment 1, the surface A is a surface of the porous film 5 which surface is opposite to a surface making contact with the heat resistant layer 4, and the surface B is a surface of the heat resistant layer 4 which surface is opposite to a surface making contact with the porous film 5.

The separator original sheet 120 which has been thus wound off is transferred to the cutting device 7 via the roller 64 and the roller 65, and is then slit into long separator sheets 12a and 12b by the cutting device 7 (see (a) and (b) of FIG. 4).

(Cutting Device and Slitting Section)

(a) of FIG. 5 is a view illustrating the cutting device 7 which operates in a shear cutting mode and is provided in the slitting apparatus 6 illustrated in FIG. 4. (b) of FIG. 5 is a view illustrating a slitting section S provided in the cutting device 7. (c) of FIG. 5 is a view illustrating a state in which the separator original sheet 120 is slit by the slitting section S of the cutting device 7.

As illustrated in (a) of FIG. 5, the cutting device 7 which operates in a shear cutting mode includes a shaft 66 and a shaft 67 each of which has a cylindrical shape. The shaft 66 and the shaft 67 are supported so as to rotate in different directions and are located on a lower side and on an upper side, respectively. The shaft 67 which is on the upper side is provided with a plurality (8 in Embodiment 1) of upper blades 67a each of which is a circular blade. As illustrated in (b) of FIG. 5, the plurality of upper blades 67a each of which is a circular blade are inserted into respective of a plurality (8 in Embodiment 1) of spaces which are provided in the shaft 66 located on the lower side. Note that, as illustrated in (a) of FIG. 5, the cutting device 7 which operates in the shear cutting mode includes a plurality (8 in Embodiment 1) of slitting sections S.

As illustrated in (c) of FIG. 5, each of the slitting sections S, which are provided in the cutting device 7 that operates in the shear cutting mode, includes (i) the upper blade 67a, (ii) lower blades 66a which are adjacent to each other in the transverse direction (TD) that is perpendicular to the lengthwise direction (MD), and (iii) a space 66b that is provided between the lower blades 66a which are adjacent to each other. Note that the lower blades 66a and the space 66b are provided in the shaft 66 that is located on the lower side.

In each of the slitting sections S, the upper blade 67a is inserted into the space 66b and makes contact with a lateral surface of one of the adjacent two lower blades 66a which one is located on a left side in (c) of FIG. 5.

An edge part of the upper blade 67a has a flat part 67b and an inclined part 67c. The flat part 67b is a part which is to make contact with the lower blade 66a. The inclined part 67c is opposite to the flat part 67b and is inclined so that the edge part of the upper blade 67a gradually becomes sharper toward a tip of the upper blade 67a.

Note that, in Embodiment 1, an example is described in which the edge part of the upper blade 67a has a cross section in which only one side is inclined but the edge part of the upper blade 67a can have a cross section of a rocking shear, or the like.

In a case where the separator original sheet 120 is slit by the slitting section S thus configured, each of the long separator sheets 12a and 12b is to have (i) a first lateral surface 12c that is shaped by the upper blade 67a (specifically, the inclined part 67c of the upper blade 67a) and the space 66b and (ii) a second lateral surface 12d that is shaped by the upper blade 67a (specifically, the flat part 67b of the upper blade 67a) and the lower blade 66a with which the upper blade 67a contacts.

In Embodiment 1, in order to inhibit the heat resistant layer 4 from being peeled off, the upper blade 67a is brought into contact with the surface A, i.e., the surface of the porous film 5 which surface is opposite to the surface making contact with the heat resistant layer 4. Note, however, that Embodiment 1 is not limited to this.

Among the plurality of long separator sheets 12a and 12b which have been slit by the plurality of slitting sections S in the cutting device 7, each of the long separator sheets 12a is transferred via the roller 68U, the roller 69U, and the first take-up assisting roller 83U, and is then wound on a cylindrical core u (bobbin) that is attached onto the first winding-up roller 70U. Moreover, each of the long separator sheets 12b among the plurality of long separator sheets 12a and 12b is transferred via the roller 68L, the roller 69L, and the second take-up assisting roller 83L, and is then wound on a cylindrical core 1 (bobbin) that is attached onto the second winding-up roller 70L. Note that the long separator sheets 12a and 12b which have been wound in rolls are referred to as separator rolls 12U and 12L.

In the separator rolls 12U and 12L, the long separator sheets 12a and 12b are wound so that the surface A of each of the long separator sheets 12a and 12b faces outside and the surface B of each of the long separator sheets 12a and 12b faces inside.

In Embodiment 1, as illustrated in (b) of FIG. 4, the separator original sheet 120 is slit into seven long separator sheets 12a and 12b (slitting step) by the eight slitting sections S in the transverse direction (TD) and along the lengthwise direction (MD). As such, four odd-numbered long separator sheets 12a and three even-numbered long separator sheets 12b are obtained. The four odd-numbered long separator sheets 12a are wound on the respective cylindrical cores u (bobbin) which are attached onto the first winding-up roller 70U, and the three even-numbered long separator sheets 12b are wound on the respective cylindrical cores 1 (bobbin) which are attached onto the second winding-up roller 70L. Note, however, that Embodiment 1 is not limited to this example, and it is of course possible to appropriately change the number of the long separator sheets 12a and 12b into which the separator original sheet 120 is slit, because the number of the long separator sheets 12a and 12b depends on a size of the separator original sheet 120 and a separator width of each of the long separator sheets 12a and 12b. Note that, in Embodiment 1, long separator sheets which are obtained on both ends by the slitting with use of the eight slitting sections S are not used.

In Embodiment 1, an example is described in which the number of long separator sheets that are wound on the respective cylindrical cores u (bobbin) provided on the first winding-up roller 70U is different from the number of long separator sheets that are wound on the respective cylindrical cores 1 (bobbin) provided on the second winding-up roller 70L. Note, however, that the number of long separator sheets that are wound on the respective cylindrical cores u can be identical with the number of long separator sheets that are wound on the respective cylindrical cores 1.

(Winding-Up Section)

On the first winding-up roller 70U (winding-up section), four cores u are detachably provided in accordance with the number of the long separator sheets 12a, i.e., the four odd-numbered long separator sheets 12a. Similarly, on the second winding-up roller 70L (winding-up section), three cores 1 are detachably provided in accordance with the number of the long separator sheets 12b, i.e., the three even-numbered long separator sheets 12b.

As illustrated in (a) of FIG. 4, the first winding-up roller 70U rotates in a direction indicated by the arrow in (a) of FIG. 4 together with the core u so as to wind up the long separator sheet 12a (winding-up step). The core u can be detached from the first winding-up roller 70U together with the long separator sheet 12a which has been wound on the core u.

Similarly, the second winding-up roller 70L rotates in a direction indicated by the arrow in (a) of FIG. 4 together with the core 1 so as to wind up the long separator sheet 12b (winding-up step). The core 1 can be detached from the second winding-up roller 70L together with the long separator sheet 12b which has been wound on the core 1.

(Touch Roller)

As illustrated in (a) of FIG. 4, the first touch roller 81U in the slitting apparatus 6 is rotatably provided at (i.e., fixed to) one end of the first arm 82U, and the second touch roller 81L in the slitting apparatus 6 is rotatably provided at (i.e., fixed to) one end of the second arm 82L. The first arm 82U can swing on a rotary shaft 84U (shaft) that is provided at the other end of the first arm 82U, and the second arm 82L can swing on a rotary shaft 84L (shaft) that is provided at the other end of the second arm 82L (in respective directions indicated by arrows in (a) of FIG. 4). The first take-up assisting roller 83U is provided between the first touch roller 81U and the rotary shaft 84U of the first arm 82U and is rotatably fixed to the first arm 82U. The second take-up assisting roller 83L is provided between the second touch roller 81L and the rotary shaft 84L of the second arm 82L and is rotatably fixed to the second arm 82L.

Note that the first and second touch rollers 81U and 81L press the long separator sheets 12a and 12b, which are to be wound up, onto winding-up surfaces (surfaces) of the separator rolls 12U and 12L, respectively. Here, the first and second touch rollers 81U and 81L press the respective long separator sheets 12a and 12b by utilizing weights of the first and second touch rollers 81U and 81L, respectively. The pressing by the first and second touch rollers 81U and 81L makes it possible to inhibit a wrinkle and the like from occurring in the long separator sheets 12a and 12b to be wound. Note that positions of the first and second touch rollers 81U and 81L change (displace) in accordance with change in outer diameters of the separator rolls 12U and 12L such that the first and second touch rollers 81U and 81L make contact with the winding-up surfaces, respectively.

(First Lateral Surface and Second Lateral Surface of Long Separator Sheet)

FIG. 6 is a view illustrating shapes of respective right and left edge parts of each of the long separator sheets 12a and 12b which have been obtained by slitting the separator original sheet 120.

(a) of FIG. 6 is a view illustrating shapes of the respective right and left edge parts obtained in a case where the surface A of each of the long separator sheets 12a and 12b is an upper surface, the surface B of each of the long separator sheets 12a and 12b is a lower surface, and the long separator sheets 12a and 12b are cut in the transverse direction (TD).

(b) of FIG. 6 is a view illustrating shapes of the respective right and left edge parts obtained in a case where the surface B of each of the long separator sheets 12a and 12b is an upper surface, the surface A of each of the long separator sheets 12a and 12b is a lower surface, and the long separator sheets 12a and 12b are cut in the transverse direction (TD).

In (b) of FIG. 6, the first lateral surface (right edge part) 12c is a lateral surface shaped by the upper blade 67a and the space 66b illustrated in (c) of FIG. 5, and the second lateral surface (left edge part) 12d is a lateral surface shaped by the upper blade 67a and the lower blade 66a with which the upper blade 67a contacts as illustrated in (c) of FIG. 5.

(c) of FIG. 6 is a view illustrating a shape of the second lateral surface (left edge part) 12d observed in a case where the surface B of each of the long separator sheets 12a and 12b is an upper surface, the surface A of each of the long separator sheets 12a and 12b is a lower surface, and the long separator sheets 12a and 12b are cut in the transverse direction (TD). (d) of FIG. 6 is a view illustrating a shape of the first lateral surface (right edge part) 12c observed in a case where the surface B of each of the long separator sheets 12a and 12b is an upper surface, the surface A of each of the long separator sheets 12a and 12b is a lower surface, and the long separator sheets 12a and 12b are cut in the transverse direction (TD).

As such, the first lateral surface (right edge part) 12c shaped by the upper blade 67a (specifically, the inclined part 67c of the upper blade 67a) and the space 66b illustrated in (c) of FIG. 5 is an inclined surface, and the second lateral surface (left edge part) 12d which is shaped by the upper blade 67a (specifically, the flat part 67b of the upper blade 67a) and the lower blade 66a with which the upper blade 67a contacts as illustrated in (c) of FIG. 5 is a curved surface.

FIG. 7 is a view illustrating shapes of the right and left edge parts in a vicinity of the surface B of each of the long separator sheets 12a and 12b.

As illustrated in (a) of FIG. 7, in Embodiment 1, the upper blade 67a is brought into contact with the surface A, i.e., the surface of the porous film 5 which surface is opposite to the surface making contact with the heat resistant layer 4 in order to inhibit the heat resistant layer 4 from being peeled off, and therefore the second lateral surface (left edge part) 12d protrudes toward a surface B (second surface) side.

Moreover, as illustrated in (b) of FIG. 7, in Embodiment 1, the upper blade 67a is brought into contact with the surface A, i.e., the surface of the porous film 5 which surface is opposite to the surface making contact with the heat resistant layer 4 in order to inhibit the heat resistant layer 4 from being peeled off. Therefore, and due to influence of the inclined part 67c of the upper blade 67a, the first lateral surface (right edge part) 12c is formed, in the transverse direction (TD), from an inner side of the surface A to an outer side of the surface B. Therefore, a part between the first lateral surface (right edge part) 12c has a part that protrudes, from the other part, in the transverse direction (TD) in the vicinity of the surface B, and as such a width of the surface A (first surface) of each of the long separator sheets 12a and 12b in the transverse direction (TD) is smaller than a width of the surface B (second surface) in the transverse direction (TD) (see (b) of FIG. 6).

FIG. 8 is a view for explaining a state of pores in the first lateral surface (right edge part) 12c and the second lateral surface (left edge part) 12d of each of the long separator sheets 12a and 12b.

(a) of FIG. 8 is a view illustrating an observed part of the second lateral surface (left edge part) 12d of each of the long separator sheets 12a and 12b.

The pores in the second lateral surface (left edge part) 12d of each of the long separator sheets 12a and 12b are damaged in the slitting, and most of the pores are thus blocked.

This seems to be because the second lateral surface (left edge part) 12d of each of the long separator sheets 12a and 12b is cut while being stretched by the upper blade 67a (specifically, the flat part 67b of the upper blade 67a) and the lower blade 66a with which the upper blade 67a contacts.

(b) of FIG. 8 is a view illustrating an observed part of the first lateral surface (right edge part) 12c of each of the long separator sheets 12a and 12b.

In the first lateral surface (right edge part) 12c of each of the long separator sheets 12a and 12b, pores are hardly damaged by the slitting and are therefore hardly blocked.

This seems to be because the first lateral surface (right edge part) 12c is formed by the cutting with the upper blade 67a (specifically, the inclined part 67c of the upper blade 67a) and the space 66b.

Note that a blocked ratio of pores in the first lateral surface (right edge part) 12c is smaller than that of pores in the second lateral surface (left edge part) 12d of each of the long separator sheets 12a and 12b.

The blocked ratio of pores means a ratio obtained by the following formula: “the number of blocked pores/the total number of pores” in a predetermined area of the first lateral surface or the second lateral surface of each of the long separator sheets 12a and 12b.

(Electrolyte Take-in Property and Retention Property in First Lateral Surface and Second Lateral Surface)

The following description will discuss an electrolyte take-in property in the first lateral surface and the second lateral surface, with reference to FIG. 9 and FIG. 10.

FIG. 9 is a view for explaining a method for evaluating an electrolyte take-in property (i.e., liquid absorption property) in a first lateral surface (right edge part) 12c′ and a second lateral surface (left edge part) 12d′ of each of long separator sheets 12a′ and 12b′ which are respectively wound into separator rolls 12U′ and 12L′.

(a) of FIG. 9 is a view illustrating the separator rolls 12U′ and 12L′ which have been respectively obtained by winding the long separator sheets 12a′ and 12b′ each of which has the first lateral surface (right edge part) 12c′ and the second lateral surface (left edge part) 12d′.

As illustrated in (b) of FIG. 9, one drop of ethanol (simulant of electrolyte) was dripped, with a dispo pipette, onto the first lateral surface (right edge part) 12c′ of each of the long separator sheets 12a′ and 12b′ which had been wound into the separator rolls 12U′ and 12L′, and then a time until the ethanol was completely absorbed was measured. Moreover, although not illustrated, each of the separator rolls 12U′ and 12L′ was turned upside down, and one drop of ethanol was dripped, with the dispo pipette, onto the second lateral surface (left edge part) 12d′ of each of the long separator sheets 12a′ and 12b′ which had been wound into the separator rolls 12U′ and 12L′. Then, a time until the ethanol was completely absorbed was measured.

Specifically, the separator rolls 12U′ and 12L′ are obtained by slitting a porous film original sheet, which does not have a heat resistant layer and is made of polyethylene, in a lengthwise direction (MD) of the original sheet and winding 200 m of slit sheets respectively on cores u and 1 having a diameter of 3 inches. Each of the cores u and 1 was caused to stand so that the first lateral surface (right edge part) 12c′ or the second lateral surface (left edge part) 12d′ formed by the slitting faces upward, and 25 μL of ethanol was dripped onto the lateral surface with use of the dispo pipette. A time T was measured which was a time period from when a droplet of ethanol attached to the lateral surface to when the droplet was absorbed inside from the lateral surface and could not be visually seen. This measurement was carried out 5 times, and an average value was calculated. The time T indicates a time required for ethanol to be absorbed from the lateral surface and, as the time T is shorter, this means that a liquid absorption property is higher.

FIG. 10 shows results of evaluating an ethanol (i.e., simulant of electrolyte) take-in property.

As shown in FIG. 10, in all the evaluations carried out 5 times, ethanol was absorbed and disappeared from the first lateral surface (right edge part) 12c′ faster than ethanol which was absorbed and disappeared from the second lateral surface (left edge part) 12d′. The average values of the 5 time evaluations were 20 seconds and 25.9 seconds, and thus a difference of the average values was clear.

The following description will discuss electrolyte retaining properties in the first lateral surface and the second lateral surface, with reference to FIG. 11 and FIG. 12.

(a) of FIG. 11 is a view for explaining a method for preparing a specimen for measuring electrolyte retaining properties in the first lateral surface and the second lateral surface. (b) of FIG. 11 is a view for explaining a method for measuring electrolyte retaining properties in the first lateral surface and the second lateral surface.

As illustrated in (a) of FIG. 11, a specimen 12e for measuring an electrolyte retaining property of the first lateral surface (right edge part) 12c′ was prepared by cutting out, with use of a cutter, the slit long porous separator sheet made of polyethylene so that the first lateral surface (right edge part) 12c′ became a lateral surface of the specimen 12e and the specimen 12e had a size of 3 cm (width)×60 cm (length). Moreover, a specimen 12f for measuring an electrolyte retaining property of the second lateral surface (left edge part) 12d′ was prepared by cutting out, with use of a cutter, the slit long porous separator sheet made of polyethylene so that the second lateral surface (left edge part) 12d′ became a lateral surface of the specimen 12f and the specimen 12f had a size of 3 cm (width)×60 cm (length).

As illustrated in (b) of FIG. 11, the specimens 12e and 12f were wound in a lengthwise direction so as to have a cylindrical shape while the first lateral surface (right edge part) 12c′ and the second lateral surface (left edge part) 12d′ face upward, and thus specimens 12g and 12h were obtained.

Each of the specimens 12g and 12h was placed in a straw 15, which was a polypropylene cylindrical container having an opened upper part, having an inner diameter of 6 mm, and having a length of 3 cm, while the first lateral surface (right edge part) 12c′ and the second lateral surface (left edge part) 12d′ faced upward.

After that, the specimens 12g and 12h were arranged so as not to protrude from the upper part of the straw 15, and then the specimens 12g and 12h were impregnated with ethanol with use of a pipette. Note that an amount of ethanol for impregnation was calculated based on the following Formula (1):

Amount of ethanol for impregnation (mL)=film thickness of specimen (cm)×3 cm (width)×60 cm (length)×voidage of specimen . . . Formula (1)

Note that the voidage was calculated based on the following Formula (2):

Voidage (%)=(1−(weight per unit area of specimen (g/m²)/film thickness of specimen (m)/density of material of specimen (g/m³))×100 . . . Formula (2)

After the specimens 12g and 12h were impregnated with ethanol, the straw 15 was placed on an electronic force balance 14 so as to vertically stand, while the first lateral surface 12c′ or the second lateral surface 12d′ faced upward. Subsequently, a zero point of the electronic force balance 14 was set, and the straw 15 was left at rest for 5 minutes.

After leaving the straw 15 at rest for 5 minutes, a reduced amount of weight (mg) was measured based on displayed values on the electronic force balance 14. The measurements were carried out 3 times, and an average value was calculated. The reduced amount of weight shows a weight of ethanol which has volatilized from each of the lateral surfaces 12c′ and 12d′ of the respective long separator sheets 12a′ and 12b′. A smaller reduced amount of weight means that ethanol is less likely to volatilize, and the liquid retention property is higher.

FIG. 12 is a view showing results of evaluating the ethanol (i.e., simulant of electrolyte) retaining property.

As shown in FIG. 12, in all the evaluations carried out 3 times, the reduced amount of weight of ethanol when the second lateral surface (left edge part) 12d′ faced upward was smaller than that obtained when the first lateral surface (right edge part) 12c′ faced upward. The average values of the 3 time evaluations were 15 mg and 22 mg, and thus a difference of the average values was clear.

From the above results, each of the first lateral surfaces 12c and 12c′, that is, the lateral surface that is in a trapezoidal shape is excellent in electrolyte take-in property (i.e., liquid absorption property), and each of the second lateral surfaces 12d and 12d′, that is, the lateral surface having a curved shape is excellent in electrolyte retaining property (i.e., liquid retention property).

Each of the long separator sheets 12a and 12b has both the first lateral surface 12c and the second lateral surface 12d, and each of the long separator sheets 12a′ and 12b′ has both the first lateral surface 12c′ and the second lateral surface 12d′. Therefore, it is possible to satisfy both a good electrolyte take-in property (i.e., liquid absorption property) and a good electrolyte retaining property (i.e., liquid retention property).

The separator (porous separator) 12 which is obtained by cutting the long separator sheet 12a, 12b, 12a′, or 12b′ in a predetermined length in the transverse direction (TD) also has both the first lateral surface 12c and the second lateral surface 12d or both the first lateral surface 12c′ and the second lateral surface 12d′. Therefore, the separator 12 can also satisfy both a good electrolyte take-in property (i.e., liquid absorption property) and a good electrolyte retaining property (i.e., liquid retention property).

[Main Points]

The long porous separator sheet in accordance with an aspect 1 of the present invention is a long porous separator sheet obtained by slitting a porous separator original sheet in a lengthwise direction of the porous separator original sheet, the long porous separator sheet including: a first lateral surface and a second lateral surface which are opposite in a transverse direction that is perpendicular to the lengthwise direction, the porous separator original sheet being slit in a first slitting section and a second slitting section, each of the first slitting section and the second slitting section including an upper blade and a lower blade which rotate in different directions, the upper blade making contact with one of two lower blades in a space formed between the two lower blades which are adjacent in the transverse direction, the first lateral surface being formed by the upper blade and the space in one of the first slitting section and the second slitting section, and the second lateral surface being formed by the upper blade and the one of two lower blades that makes contact with the upper blade in the other of the first slitting section and the second slitting section.

According to the configuration, the long porous separator sheet has (i) the first lateral surface that is formed by the upper blade and the space in one of the first slitting section and the second slitting section and (ii) the second lateral surface that is formed by the upper blade and the one of two lower blades that makes contact with the upper blade in the other of the first slitting section and the second slitting section.

When the porous separator original sheet is slit in the first and second slitting sections, the pores in the first lateral surface formed by the upper blade and the space are hardly damaged. Meanwhile, in the second lateral surface formed by the upper blade and the one of two lower blades that makes contact with the upper blade, the pores are damaged by the slitting.

As such, in the first lateral surface and the second lateral surface of the long porous separator sheet, damages to the pores vary greatly, and thus the first lateral surface becomes a lateral surface having a good electrolyte take-in property (i.e., liquid absorption property) and the second lateral surface becomes a lateral surface having a good electrolyte retaining property (i.e., liquid retention property).

Therefore, it is possible to provide the long porous separator sheet which satisfies both a good electrolyte take-in property (i.e., liquid absorption property) and a good electrolyte retaining property (i.e., liquid retention property).

The long porous separator sheet in accordance with an aspect 2 of the present invention is a long porous separator sheet including a first lateral surface and a second lateral surface which are opposite in a transverse direction that is perpendicular to a lengthwise direction, the first lateral surface being an inclined plane, and the second lateral surface being a curved surface.

According to the configuration, the long porous separator sheet has the first lateral surface which is an inclined plane and the second lateral surface which is a curved surface.

When the second lateral surface which is the curved surface is formed, the second lateral surface of the long porous separator sheet is stretched, and therefore pores in the vicinity of the second lateral surface are damaged. Meanwhile, the first lateral surface of the long porous separator sheet is the inclined plane, and therefore pores in the vicinity of the first lateral surface are hardly damaged.

As such, in the first lateral surface and the second lateral surface of the long porous separator sheet, damages to the pores vary greatly, and thus the first lateral surface becomes a lateral surface having a good electrolyte take-in property (i.e., liquid absorption property) and the second lateral surface becomes a lateral surface having a good electrolyte retaining property (i.e., liquid retention property).

Therefore, it is possible to provide the long porous separator sheet which satisfies both a good electrolyte take-in property (i.e., liquid absorption property) and a good electrolyte retaining property (i.e., liquid retention property).

The long porous separator sheet in accordance with an aspect 3 of the present invention is a long porous separator sheet including a first lateral surface and a second lateral surface which are opposite in a transverse direction that is perpendicular to a lengthwise direction, a blocked ratio of pores in the first lateral surface being smaller than that in the second lateral surface.

According to the configuration, in the long porous separator sheet, a blocked ratio of pores in the first lateral surface is smaller than that in the second lateral surface.

From this, the first lateral surface of the long porous separator sheet becomes a lateral surface having a good electrolyte take-in property (i.e., liquid absorption property), and the second lateral surface becomes a lateral surface having a good electrolyte retaining property (i.e., liquid retention property).

Therefore, it is possible to provide the long porous separator sheet which satisfies both a good electrolyte take-in property (i.e., liquid absorption property) and a good electrolyte retaining property (i.e., liquid retention property).

In the long porous separator sheet in accordance with an aspect 4 of the present invention, it is possible in the aspect 1 that an edge part of the upper blade has a flat part and an inclined part that is opposite to the flat part, the flat part making contact with the one of two lower blades; the first lateral surface which is formed by the inclined part and the space is an inclined plane; and the second lateral surface which is formed by the flat part and the one of two lower blades is a curved surface.

According to the configuration, it is possible to provide the long porous separator sheet which has the first lateral surface that is an inclined plane and the second lateral surface that is a curved surface.

It is possible, in any one of the aspects 1 through 4, that the long porous separator sheet in accordance with an aspect 5 of the present invention has a first surface and a second surface which are opposite in a thickness direction, a width of the first surface in the transverse direction being smaller than a width of the second surface in the transverse direction.

According to the configuration, it is possible to provide the long porous separator sheet in which a width of the first surface in the transverse direction is smaller than a width of the second surface in the transverse direction.

In the long porous separator sheet in accordance with an aspect 6 of the present invention, it is possible in the aspect 5 that the second lateral surface protrudes toward a second surface side.

According to the configuration, it is possible to provide the long porous separator sheet in which the second lateral surface protrudes toward the second surface side.

In the long porous separator sheet in accordance with an aspect 7 of the present invention, it is possible in the aspect 5 or 6 that the first surface is a surface of a porous film layer; and the second surface is a surface of a porous heat resistant layer.

According to the configuration, it is possible to provide the long porous separator sheet in which the first surface is a surface of a porous film layer and the second surface is a surface of a porous heat resistant layer.

The porous separator roll in accordance with an aspect 8 of the present invention is configured by winding the long porous separator sheet described in any one of the aspects 1 through 7 on a core.

According to the configuration, it is possible to provide the porous separator roll obtained by winding the long porous separator sheet that satisfies both a good electrolyte take-in property (i.e., liquid absorption property) and a good electrolyte retaining property (i.e., liquid retention property).

The lithium-ion battery in accordance with an aspect 9 of the present invention includes a porous separator which has been obtained by cutting, in a predetermined length, the long porous separator sheet described in any one of the aspects 1 through 7 in the transverse direction.

According to the configuration, it is possible to provide the lithium-ion battery including the porous separator that satisfies both a good electrolyte take-in property (i.e., liquid absorption property) and a good electrolyte retaining property (i.e., liquid retention property).

A method in accordance with an aspect 10 of the present invention for producing a long porous separator sheet includes the step of slitting a porous separator original sheet in a lengthwise direction of the porous separator original sheet, in the slitting step, a first lateral surface and a second lateral surface being formed, which are opposite in a transverse direction that is perpendicular to the lengthwise direction, with use of a first slitting section and a second slitting section, each of the first slitting section and the second slitting section including an upper blade and a lower blade which rotate in different directions, the upper blade making contact with one of two lower blades in a space formed between the two lower blades which are adjacent in the transverse direction, the first lateral surface being formed by the upper blade and the space in one of the first slitting section and the second slitting section, and the second lateral surface being formed by the upper blade and the one of two lower blades that makes contact with the upper blade in the other of the first slitting section and the second slitting section.

According to the method, it is possible to provide a method for producing a long porous separator sheet which satisfies both a good electrolyte take-in property (i.e., liquid absorption property) and a good electrolyte retaining property (i.e., liquid retention property).

In the long porous separator sheet production method in accordance with an aspect 11 of the present invention, it is possible in the aspect 10 that an edge part of the upper blade, which is provided in each of the first slitting section and the second slitting section used in the slitting step, has a flat part and an inclined part that is opposite to the flat part, the flat part making contact with the one of two lower blades; the first lateral surface which is formed by the inclined part and the space is an inclined plane; and the second lateral surface which is formed by the flat part and the one of two lower blades is a curved surface.

According to the method, it is possible to provide the method for producing a long porous separator sheet which has a first lateral surface that is an inclined plane and a second lateral surface that is a curved surface.

[Additional Remarks]

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention can be used in a long porous separator sheet, a roll of the long porous separator sheet, methods for producing the long porous separator sheet and the roll, a lithium-ion battery, and the like.

### REFERENCE SIGNS LIST

1: Lithium-ion secondary battery (lithium-ion battery)
4: Heat resistant layer (porous heat resistant layer)
5: Porous film (porous film layer)
6: Slitting apparatus
7: Cutting device
12: Separator
12a: Long separator sheet
12b: Long separator sheet
12a′: Long separator sheet
12b′: Long separator sheet
12c: Right edge part, upper side edge part (first lateral surface)
12d: Left edge part, lower side edge part (second lateral surface)
12c′: Right edge part, upper side edge part (first lateral surface)
12d′: Left edge part, lower side edge part (second lateral surface)
12U: Separator roll
12L: Separator roll
12U′: Separator roll
12L′: Separator roll
120: Separator original sheet
66: Lower shaft
66a: Lower blade
66b: Space
67: Upper shaft
67a: Upper blade
67b: Flat part
67c: Inclined part
1: Core
u: Core
MD: Lengthwise direction of long separator sheet or separator original sheet
TD: Transverse direction of long separator sheet or separator original sheet
S: Slitting section
Surface A: Surface of porous film which surface is opposite to surface making contact with heat resistant layer (first surface)
Surface B: Surface of heat resistant layer which surface is opposite to surface making contact with porous film (second surface)

1. A long porous separator sheet obtained by slitting a porous separator original sheet in a lengthwise direction of the porous separator original sheet, said long porous separator sheet comprising:
a first lateral surface and a second lateral surface which are opposite in a transverse direction that is perpendicular to the lengthwise direction,
the porous separator original sheet being slit in a first slitting section and a second slitting section, each of the first slitting section and the second slitting section including an upper blade and a lower blade which rotate in different directions, the upper blade making contact with one of two lower blades in a space formed between the two lower blades which are adjacent in the transverse direction,
the first lateral surface being formed by the upper blade and the space in one of the first slitting section and the second slitting section,
the second lateral surface being formed by the upper blade and one of the two lower blades that makes contact with the upper blade in the other of the first slitting section and the second slitting section, and
a blocked ratio of pores in the first lateral surface being smaller than that in the second lateral surface.

2. A long porous separator sheet comprising a first lateral surface and a second lateral surface which are opposite in a transverse direction that is perpendicular to a lengthwise direction and which are cut surfaces,
the first lateral surface being an inclined plane,
the second lateral surface being a curved surface, and
a blocked ratio of pores in the first lateral surface being smaller than that in the second lateral surface.

3. A long porous separator sheet comprising a first lateral surface and a second lateral surface which are opposite in a transverse direction that is perpendicular to a lengthwise direction and which are cut surfaces,
a blocked ratio of pores in the first lateral surface being smaller than that in the second lateral surface.

4. The long porous separator sheet as set forth in claim 1, wherein:
an edge part of the upper blade has a flat part and an inclined part that is opposite to the flat part, the flat part making contact with the one of two lower blades;
the first lateral surface which is formed by the inclined part and the space is an inclined plane; and
the second lateral surface which is formed by the flat part and the one of two lower blades is a curved surface.

5. The long porous separator sheet as set forth in claim 1, comprising a first surface and a second surface which are opposite in a thickness direction,
a width of the first surface in the transverse direction being smaller than a width of the second surface in the transverse direction.

6. The long porous separator sheet as set forth in claim 5, wherein the second lateral surface protrudes toward the second surface side.

7. (canceled)

8. A porous separator roll obtained by winding the long porous separator sheet recited in claim 1 on a core.

9. A lithium-ion battery, comprising:
a porous separator which has been obtained by cutting, in a predetermined length, the long porous separator sheet recited in claim 1 in the transverse direction.

10. A method for producing a long porous separator sheet, said method comprising the step of slitting a porous separator original sheet in a lengthwise direction of the porous separator original sheet,
in the slitting step, a first lateral surface and a second lateral surface being formed, which are opposite in a transverse direction that is perpendicular to the lengthwise direction, with use of a first slitting section and a second slitting section, each of the first slitting section and the second slitting section including an upper blade and a lower blade which rotate in different directions, the upper blade making contact with one of two lower blades in a space formed between the two lower blades which are adjacent in the transverse direction,
the first lateral surface being formed by the upper blade and the space in one of the first slitting section and the second slitting section, and
the second lateral surface being formed by the upper blade and the one of two lower blades that makes contact with the upper blade in the other of the first slitting section and the second slitting section, and
a blocked ratio of pores in the first lateral surface being smaller than that in the second lateral surface.

11. The method as set forth in claim 10, wherein:
an edge part of the upper blade, which is provided in each of the first slitting section and the second slitting section used in the slitting step, has a flat part and an inclined part that is opposite to the flat part, the flat part making contact with the one of two lower blades;
the first lateral surface which is formed by the inclined part and the space is an inclined plane; and
the second lateral surface which is formed by the flat part and the one of two lower blades is a curved surface.
